(19) United States
(12) Patent Application Publication
(10) Pub. No.: US 2019/0057482 A1
(43) Pub. Date: Feb. 21, 2019

(54) METHOD AND SYSTEM FOR PROVIDING TRANSPORTATION SERVICE

(71) Applicant: BEIJING DIDI INFINITY TECHNOLOGY AND DEVELOPMENT CO., LTD., Beijing (CN)

(72) Inventors: Xiang LI, Beijing (CN); Zhiqiang ZHOU, Beijing (CN); Zhan WANG, Beijing (CN); Kehua SHENG, Beijing (CN); Niping ZHANG, Beijing (CN)

(73) Assignee: BEIJING DIDI INFINITY TECHNOLOGY AND DEVELOPMENT CO., LTD., Beijing (CN)

(21) Appl. No.: 15/862,268

(22) Filed: Jan. 4, 2018

(30) Foreign Application Priority Data
Aug. 16, 2017 (CN) 201710701708.3

(51) Int. Cl. G06Q 50/30; G06Q 10/02; H04W 4/02

(52) U.S. Cl. CPC G06Q 50/30; H04W 88/02; H04W 4/02; G06Q 10/02

(57) ABSTRACT

Embodiments of the disclosure provide methods and systems for providing transportation service. The method can include receiving, from a remote passenger terminal, a transportation service request in a district. The method can further include detecting that the transportation service request is within a first queuing zone, the first queuing zone associated with at least one first queuing condition. The method can also include placing the transportation service request in a first request queue associated with the first queuing zone based on a determination that the transportation service request meets the first queuing condition.

### CROSS REFERENCE TO RELATED APPLICATION

The present application is based on and claims the benefits of priority to Chinese Application No. 201710701708.3, filed Aug. 16, 2017, the entire contents of which are incorporated herein by reference.

### TECHNICAL FIELD

The present disclosure relates to providing transportation service, and more particularly to, methods and systems for queuing a transportation service request.

### BACKGROUND

An online hailing platform (e.g., DiDi™ online) can receive a transportation service request from a passenger and then dispatch at least one transportation service provider (e.g., a taxi driver, a private car owner, or the like) to fulfill the service request. During certain time periods of a day, the online hailing platform can receive more transportation service requests in a certain district than the capacity of the available service vehicles in the district. Accordingly, the transportation service requests are typically lined up in a queue before being processed. However, establishing a queue consumes significant computational and storage resources. Therefore, it is inefficient to activate a queue whenever a transportation service cannot be processed immediately.

Methods and systems for providing transportation service are designed to place a transportation service request in a request queue associated with a queue zone and improve the efficiency of the online hailing platform.

### SUMMARY

An embodiment of the disclosure provides a computer-implemented method for providing transportation service. The method can include receiving, from a remote passenger terminal, a transportation service request in a district. The method can further include detecting that the transportation service request is within a first queuing zone, the first queuing zone associated with at least one first queuing condition. The method can also include placing the transportation service request in a first request queue associated with the first queuing zone based on a determination that the transportation service request meets the first queuing condition.

Another embodiment of the disclosure provides a system for providing transportation service. The system can include a communication interface configured to receive from a remote passenger terminal, a transportation service request in a district. The system can further include a memory and at least one processor coupled to the communication interface and the memory. The at least one processor can be configured to detect that the transportation service request is within a first queuing zone, the first queuing zone associated with at least one first queuing condition. The at least one processor can be further configured to place the transportation service request in a first request queue associated with the first queuing zone based on a determination that the transportation service request meets the first queuing condition.

Yet another embodiment of the disclosure provides a non-transitory computer-readable medium that stores a set of instructions. When the set of instructions is executed by at least one processor of an electronic device, the electronic device can be caused to perform a method for providing transportation service. The method can include receiving, from a remote passenger terminal, a transportation service request in a district. The method can further include detecting that the transportation service request is within a first queuing zone, the first queuing zone associated with at least one first queuing condition. The method can also include placing the transportation service request in a first request queue associated with the first queuing zone based on a determination that the transportation service request meets the first queuing condition.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary system for providing transportation service, according to embodiments of the disclosure.

FIG. 2 illustrates a schematic diagram showing transportation service requests in a district, according to embodiments of the disclosure.

FIG. 3 illustrates a schematic diagram of an exemplary queue generation unit, according to embodiments of the disclosure.

FIG. 4 is a flowchart of an exemplary method for providing transportation service, according to embodiments of the disclosure.

FIG. 5 is a flowchart of an exemplary method for generating a queuing zone, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

An aspect of the disclosure is directed to a system for providing transportation service.

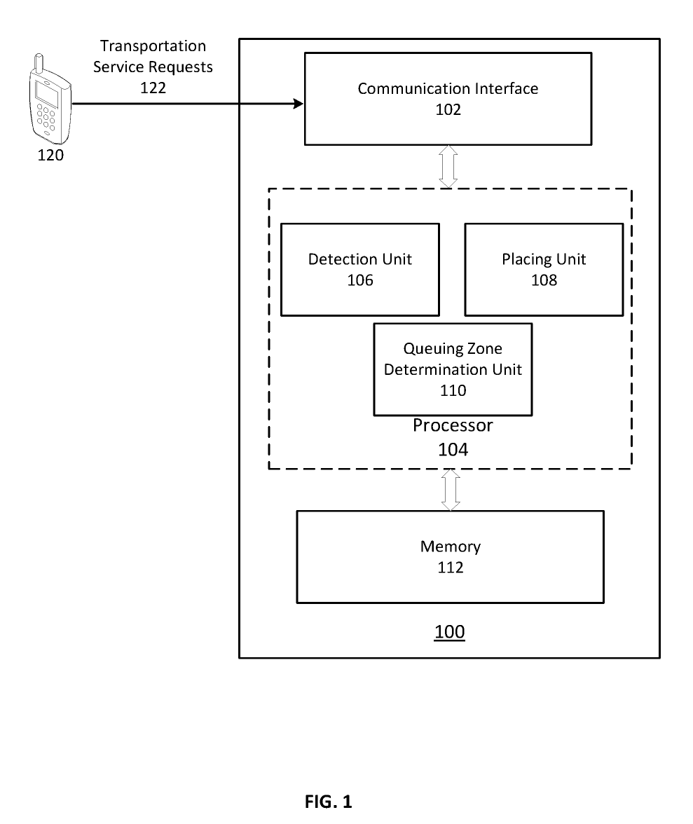

FIG. 1 illustrates a schematic diagram of a system 100 for providing transportation service, according to embodiments of the disclosure.

System 100 can be a general-purpose server or a proprietary device specially designed for providing transportation service. It is contemplated that, system 100 can be a separate system (e.g., a server) or an integrated component of a server. Because processing transportation service requests may require significant computation resources, in some embodiments, system 100 may be preferably implemented as a separate system. In some embodiments, system 100 may include sub-systems, some of which may be remote.

In some embodiments, as shown in FIG. 1, system 100 may include a communication interface 102, a processor 104, and a memory 112. Processor 104 may further include multiple modules, such as a detection unit 106, a placing unit 108, a queuing zone determination unit 110, and the like. These modules (and any corresponding sub-modules or sub-units) can be hardware units (e.g., portions of an integrated circuit) of processor 104 designed for use with other components or to execute a part of a program. The program may be stored on a computer-readable medium, and when executed by processor 104, it may perform one or more methods. Although FIG. 1 shows units 106-110 all within one processor 104, it is contemplated that these units may be distributed among multiple processors located near or remotely with each other. In some embodiments, system 100 may be implemented in the cloud, or on a separate computer/server.

Communication interface 102 may be configured to receive, from remote passenger terminals 120, transportation service requests 122 in a district. Remote passenger terminal 120 can be any suitable device that can interact with a user, e.g., a smart phone, a tablet, a wearable device, a computer, or the like. Remote passenger terminal 120 may be a mobile device that can be carried by the user. Transportation service request 122 can include a current location of the passenger, an origin and a destination of the requested transportation, a request time, or the like. For example, the current location of the passenger can be the location of transportation service request 122.

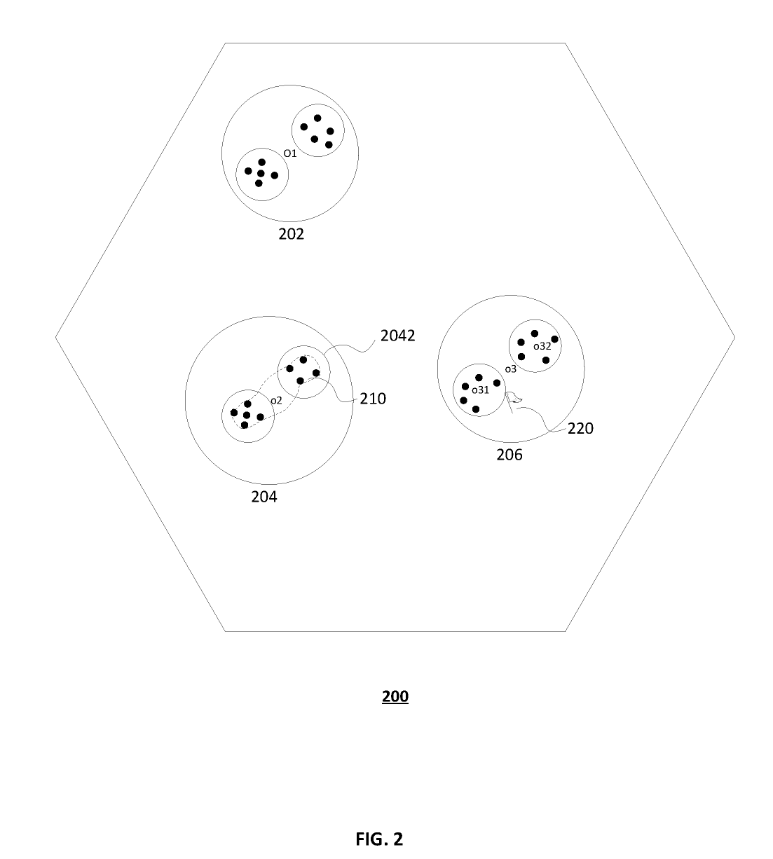

In some embodiments, the district can be predetermined by system 100. For example, the district can be a hexagonal area that is neighbored with other hexagonal areas. It is contemplated that, the district can have shapes other than a hexagon, such as a circle, a square, a rectangle, etc. In some embodiments, the district can have a shape and size dynamically determined based on the current location of remote passenger terminal 120. FIG. 2 illustrates a schematic diagram showing transportation service requests in a district 200, according to embodiments of the disclosure. As shown in FIG. 2, for example, district 200 is a hexagonal district. In some embodiments, district 200 may include a plurality of queuing zones, such as 2042.

In some embodiments, communication interface 102 can be an integrated services digital network (ISDN) card, cable modem, satellite modem, or a modem to provide a data communication connection. As another example, communication interface 102 can be a local area network (LAN) card to provide a data communication connection to a compatible LAN. Wireless links can also be implemented by communication interface 102. In such an implementation, communication interface 102 can send and receive electrical, electromagnetic or optical signals that carry digital data streams representing various types of information via a network. The network can typically include a cellular communication network, a Wireless Local Area Network (WLAN), a Wide Area Network (WAN), or the like.

Detection unit 106 can detect that transportation service request 122 is within a queuing zone. As discussed above, district 200 can include a plurality of queuing zones, such as queuing zones 202, 204, and 206. Detection unit 106 can determine whether transportation service request 122 is within a zone of district 200 based on the location of transportation service request 122 and the geographic boundary of the zone. For example, detection unit 106 may determine that transportation service request 122 is within zone 202.

In some embodiments, the detected queuing zone can be associated with at least one queuing condition. Consistent with the disclosure, queues are not activated until the queuing conditions are met. For example, one queuing condition can be that the number of the existing requests in the queue must be over a threshold number. As another example, a queuing condition may be that the type of the request has to match the type of the queue, such as car-pooling or non-car-pooling. The queuing condition may also be that the service vehicle line (e.g., economic, luxury, corporate, etc.) matches that of the queue. As yet another example, the queuing condition may include that the request be made during a predetermined period of time. It is contemplated that queuing conditions may include other suitable conditions, and any combinations of the conditions. Detection unit 106 can determine whether transportation service request 122 meets the queuing conditions. For example, when the number of car-pooling service requests in the queuing zone is 100, a car-pooling queue can be activated to queue the 100 car-pooling requests within the queuing zone.

After detection unit 106 detects the queuing zone and determines that transportation service request 122 meets the queuing condition of the queuing zone, placing unit 108 can place transportation service request 122 in a queue associated with the detected queuing zone.

In some embodiments, the queuing zones can be determined using clustering by queuing zone determination unit 110. In one embodiment, the queuing zones can be determined manually based on historical requests. For example, based on the origins of trips associated with the historical requests, queuing zone determination unit 110 can cluster the origins into a plurality of origin groups. Queuing zone determination unit 110 can then identify some origin groups that contain more historical requests than the remaining, and determine frequent origins based on the identified origin groups. Queuing zone determination unit 110 can further cluster the frequent origins and generate the queuing zones based on these clusters.

In an alternative embodiment, the queuing zones can also be determined automatically. For example, with reference to FIG. 2, queuing zone 2042 can be determined automatically by queuing zone determination unit 110 based on historical requests. For instance, a “double-clustering” method may be used, where queuing zone determination unit 110 can cluster the historical requests into a plurality of first clusters, cluster historical requests enclosed by each of the first clusters into a plurality of secondary clusters, and determine the queuing zone enclosing a second cluster.

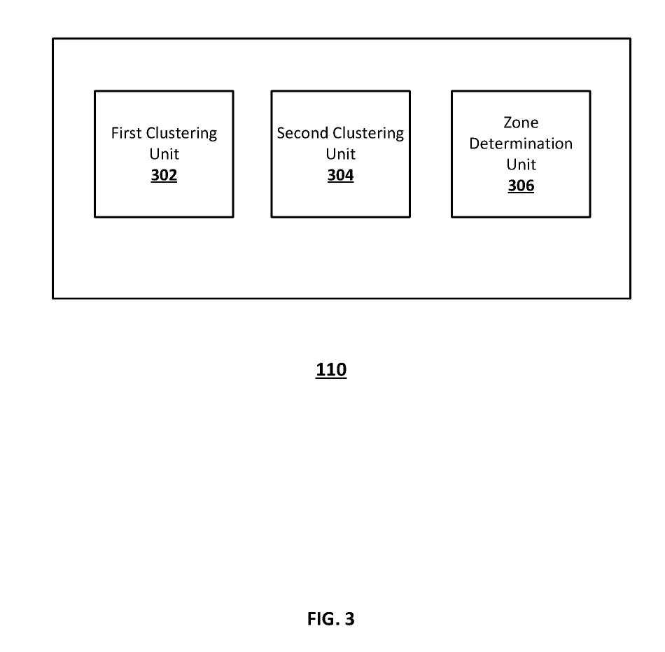

FIG. 3 illustrates a schematic diagram of queuing zone determination unit 110 configured to implement the “double-clustering” method, according to embodiments of the disclosure. Queuing zone determination unit 110 can include a first clustering unit 302, a second clustering unit 304, and a zone determination unit 306. Each of units 302-306 can be hardware units (e.g., portions of an integrated circuit) configured to execute a part of a computer program. In some embodiments, first clustering unit 302 and second clustering unit 304 can perform the “double-clustering” method, and zone determination unit 306 can determine a queuing zone based on the clustering results of the “double-clustering” method including a first clustering and a second clustering, which will be further described as below.

In the first clustering, with reference to FIG. 2, for example, first clustering unit 302 can cluster the historical requests (shown as dots) into a plurality of first clusters 202, 204 and 206. In some embodiments, first clustering unit 302 can use a K-means clustering method. The K-means clustering method can classify input data (e.g., historical requests) into a predetermined number of clusters. For example, as shown in FIG. 2, the predetermined number of first clusters (e.g., 202, 204, and 206) is three. In some embodiments, the first number of clusters can be determined based on an area of district 200 and a predetermine minimum area value. For example, the number of first clusters can be determined according to Formula 1 as below.

n₁=\sqrt{Sₛᵤₘ/Sₘᵢₙ} (Formula 1)

Where in Formula 1, n₁ is the first number, Sₛᵤₘ is the total area of district 200, and Sₘᵢₙ is the predetermined minimum area value. In some embodiments, Sₘᵢₙ can be 1.5 km². It is contemplated that any other suitable clustering method may be implemented by first clustering unit 302.

In the second clustering, second clustering unit 304 can cluster historical requests within each of the first clusters (e.g., first cluster 204) into a plurality of second clusters (e.g., second cluster 2042). Second clustering unit 304 can also implement the K-means clustering method or another appropriate clustering method. In FIG. 2, for example, historical requests within first cluster 204 can be clustered into a number of second clusters 2042, and the second number is two. In some embodiments, the number of second clusters can be determined based on convex hull areas of historical requests in each of the n₁ first clusters, the predetermined minimum area value, and the number of the first clusters.

For example, area 210 enclosed by a dashed line is the convex hull area of the historical requests in first cluster 204. Accordingly, the second number of second clusters can be determine according to Formula 2.

n₂=min{Sᵢ/Sₘᵢₙ,n₁}, i∈(0,1] (Formula 2)

Where in Formula 2, n₂ is the second number, Sᵢ is the convex hull area for historical requests in first cluster 204, Sₘᵢₙ is the predetermined value, and n₁ is the number of first clusters. Formula 2 selects a lesser value between Sᵢ/Sₘᵢₙ and n₁ for each first cluster, as the predetermined number for the second clustering. Therefore, the second number n₂ is equal to or less than the first number n₁. As shown in FIG. 2, the second number for cluster 204 is two.

Zone determination unit 306 can further determine a second queuing zone enclosing the selected second cluster (e.g., 2042). For example, the second queuing zone can be determined to cover locations of the historical requests enclosed by the second cluster. Zone determination unit 306 can generate a second queuing zone for each of the second clusters. For example, in FIG. 2, six second clusters in total have been determined, and zone determination unit 306 can generate six second queuing zones for the six respective second clusters. That is, each second cluster has a corresponding second queuing zone.

As more than one second queuing zones can be provided, placing unit 108 can be further configured to determine a request queue in which the transportation service request will be placed when the transportation service request meets the condition associated with the second queuing zone.

The connection between the second request queue and the transportation service request can be the location. For example, the transportation service can be placed to a closest second request queue when the at least one second queuing condition has been met.

To determine the closest second request queue, placing unit 108 can first determine respective first locations for the first clusters, and determine respective second locations for the second clusters. For example, with reference to FIG. 2, placing unit 108 can determine the respective locations o1, o2, and o3 of first clusters 202, 204, and 206. In some embodiments, the locations of the first clusters can be the centroids of the first clusters. Similarly, placing unit 108 can determine respective second locations (e.g., o31 and o32) for the second clusters.

Placing unit 108 can further determine a request location of the transportation service request. In some embodiments, the current location of the passenger can be used as the location of the transportation service request (e.g., request location 220 as shown in FIG. 2).

Placing unit 108 can determine a first cluster having a first location corresponding to the request location. In some embodiments, the determined first cluster is closest to the request location among the first clusters. For example, in FIG. 2, location o3 among locations o1-o3 is the closest to request location 220, and therefore first cluster 206 corresponding to location o3 is determined.

Then, within the determined first cluster (e.g., 206), placing unit 108 can further determine, among second clusters enclosed by the first cluster, a second cluster having a second location corresponding to the request location. Similarly, the determined second cluster can be the closest to the request location among the second clusters. For example, in FIG. 2, two second clusters having respective locations o31 and o32 are enclosed by first cluster 206. Among these two second clusters, the second cluster at location o31 is determined to be the closest to request location 220.

As discussed above, a corresponding second queuing zone is determined for each second cluster. Based on the determined second queuing zone, placing unit 108 can determine the second request queue associated with the second queuing zone.

As discussed above, after the second request queue is determined, placing unit 108 can place the transportation service request in the determined second request queue.

Another aspect of the disclosure is directed to a method for providing transportation service.

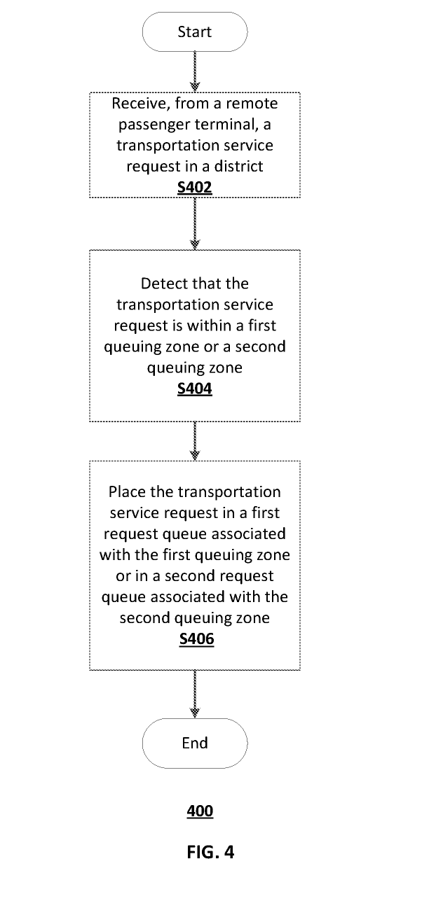

FIG. 4 is a flowchart of a method 400 for providing transportation service, according to embodiments of the disclosure. For example, method 400 may be implemented by system 100 including at least one processor, and method 400 may include steps S402-S406 as described below.

In step S402, system 100 can receive, from remote passenger terminals, transportation service requests in a district. The transportation service request can include a current location of a passenger, an origin and a destination of the requested transportation, a request time, or the like. Generally, the current location of the passenger can be used as a location of the transportation service request. In some embodiments, the district can be predetermined by system 100, and have a shape and size dynamically determined based on the current locations of the remote passenger terminals.

In step S404, system 100 can detect that the transportation service request is within a first queuing zone or a second queuing zone. The district can include a plurality of queuing zones, and each zone can be associated with a request queue. The zones can be created automatically or manually. The first queuing zone can be associated with at least one first queuing condition, and the second queuing zone can be associated with at least one second queuing condition. Consistent with the disclosure, queues are not activated until the queuing conditions (e.g., the first and second queuing conditions) are met. For example, one queuing condition can be that the number of the existing requests in the queue must be over a threshold number. As another example, a queuing condition may be that the type of the request has to match the type of the queue, such as car-pooling or non-car-pooling. The queuing condition may also be that the service vehicle line (e.g., economic, luxury, corporate, etc.) matches that of the queue. As yet another example, the queuing condition may include that the request be made during a predetermined period of time. It is contemplated that queuing conditions may include other suitable conditions, and any combinations of the conditions.

In some embodiments, the first queuing zone can be created manually based on historical requests. For example, based on the origins of trips associated with the historical requests, system 100 can cluster the origins into a plurality of origin groups. System 100 can then identify, among the origin groups that contain more historical requests than the remaining, and determine frequent origins based on the identified origin groups. System 100 can further cluster the frequent origins and generate the queuing zones based on these clusters. After a first queuing zone has been generated, the request queue corresponding to the first queuing zone can be determined.

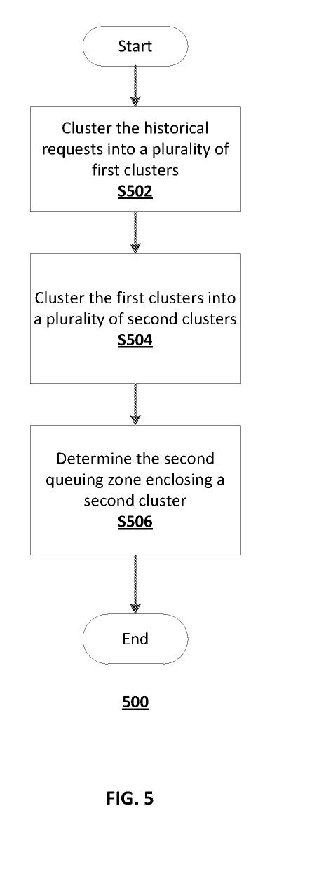

It is contemplated that, it is possible that the transportation service request may not fall within the first queuing zone nor meet the at least one first queuing condition. Therefore, in some embodiments, system 100 can further detect that the transportation service request is within a second queuing zone. The second queuing zone can be associated with at least one second queuing condition. The second queuing zone can be determined by identifying historical requests within the district, clustering the historical requests, and determining the second queuing zone within the district based on clustering of the historical requests. The step of generating the second queuing zone can be further referred to FIG. 5. FIG. 5 illustrates a flowchart of a method 500 for generating a queuing zone, according to embodiments of the disclosure. For example, method 500 may be implemented by system 100 as a separate method or a part of method 500. Method 500 may include steps S502-S506 as described below.

In step S502, system 100 can cluster the historical requests into a plurality of first clusters. System 100 can use a K-means clustering method. The K-means clustering method can classify input data (e.g., historical requests) into a predetermined number of clusters.

The first number of clusters can be determined based on an area of the district and a predetermine value. For example, the first number of first clusters can be determine according to Formula 1, details of which will not be repeated herein.

In step S504, system 100 can cluster historical requests within each of the first clusters into a plurality of second clusters. System 100 can continue using the K-means clustering method or another appropriate clustering method. The second number of clusters can be determined based on convex hull areas of historical requests in each of the n₁ first clusters, the predetermined value, and the first number. The second number of second clusters can be determined according to Formula 2, details of which will not be repeated herein.

In step S506, system 100 can further determine a second queuing zone enclosing the selected second cluster. For example, the second queuing zone can be determined to cover locations of historical requests that belong to the second cluster.

With reference back to FIG. 4, in step S406, system 100 can place the transportation service request in a first request queue associated with the first queuing zone or in a second request queue associated with the second queuing zone.

Because the first queuing zone is predetermined, the first request queue associated with the first queuing zone can be predetermined. However, a plurality of second queuing zones can be generated automatically by system 100, system 100 can be further configured to determine a second request queue with the second queuing zone for the transportation service request.

System 100 can further determine respective first locations for the first clusters generated in step S502, and determine respective second locations for the second clusters generated in step S504. Then, system 100 can determine a request location of the transportation service request. System 100 can determine a first cluster having a first location corresponding to the request location. In some embodiments, the determined first cluster is closest to the request location among the first clusters.

Then, within the determined first cluster, system 100 can further determine, among second clusters enclosed by the first cluster, a second cluster having a second location corresponding to the request location. Similarly, the determined second cluster can be the closest to the request location among the second clusters. Thus, system 100 can determine the second request queue corresponding to the determined second cluster.

As discussed above, after the second request queue is determined, system 100 can place the transportation service request in the determined second request queue.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for providing transportation service, comprising:
receiving, from a remote passenger terminal, a transportation service request in a district;
detecting that the transportation service request is within a first queuing zone, the first queuing zone associated with at least one first queuing condition; and
placing the transportation service request in a first request queue associated with the first queuing zone based on a determination that the transportation service request meets the first queuing condition.

2. The method of claim 1, further comprising:
detecting that the transportation service request is within a second queuing zone, the second queuing zone associated with at least one second queuing condition; and
placing the transportation service request in a second request queue associated with the second queuing zone based on a determination that the transportation service request meets the second queuing condition.

3. The method of claim 2, wherein the second queuing zone is determined by:
identifying historical requests within the district;
clustering the historical requests; and
determining the second queuing zone within the district based on clustering of the historical requests.

4. The method of claim 3, wherein determining the second queuing zone further comprises:
clustering the historical requests into a plurality of first clusters;
clustering historical requests within each of the first clusters into a plurality of secondary clusters; and
determining the second queuing zone enclosing a second cluster.

5. The method of claim 4, further comprising:
determining respective first locations for the first clusters; and
determining respective second locations for the second clusters.

6. The method of claim 5, wherein placing the transportation service request in a second request queue associated with the second queuing zone further comprises:
determining a request location of the transportation service request;
determining a first cluster having a first location corresponding to the request location;
determining, among second clusters enclosed by the first cluster, a second cluster having a second location corresponding to the request location; and
determining the second request queue corresponding to the determined second cluster.

7. The method of claim 4, wherein a first number of the first clusters is associated with an area of the district and a predetermined value.

8. The method of claim 7, further comprising: determining convex hull areas associated with the first clusters, wherein
a second number of the second clusters is associated with the convex hull areas, the predetermined value, and the first number.

9. The method of claim 6, wherein the determined first cluster is closest to the request location among the first clusters, and the determined second cluster is closest to the request location among the second clusters.

10. The method of claim 7, wherein the first number is determined based on
n₁=\sqrt{Sₛᵤₘ/Sₘᵢₙ},
wherein n₁ is the first number, Sₛᵤₘ is an area of the district, and Sₘᵢₙ is the predetermined value.

11. The method of claim 8, wherein the second number is determined based on
n₂=min{Sᵢ/Sₘᵢₙ,n₁}, i∈(0,1],
wherein n₂ is the second number, Sᵢ is the convex hull area, Sₘᵢₙ is the predetermined value, and n₁ is the first number.

12. A system for providing transportation service, comprising:
a communication interface configured to receive from a remote passenger terminal, a transportation service request in a district;
a memory; and
at least one processor coupled to the communication interface and the memory, configured to:
detect that the transportation service request is within a first queuing zone, the first queuing zone associated with at least one first queuing condition; and
place the transportation service request in a first request queue associated with the first queuing zone based on a determination that the transportation service request meets the first queuing condition.

13. The system of claim 12, wherein the at least one processor is further configured to:
detect that the transportation service request is within a second queuing zone, the second queuing zone associated with at least one second queuing condition; and
place the transportation service request in a second request queue associated with the second queuing zone based on a determination that the transportation service request meets the second queuing condition.

14. The system of claim 13, wherein the at least one processor is further configured to determine the second queuing zone by:
identifying historical requests within the district;
clustering the historical requests; and
determining the second queuing zone within the district based on clustering of the historical requests.

15. The system of claim 14, wherein the at least one processor is further configured to determine the second queuing zone by:
clustering the historical requests into a plurality of first clusters;
clustering historical requests within each of the first clusters into a plurality of secondary clusters; and
determining the second queuing zone enclosing a second cluster.

16. The system of claim 15, wherein the at least one processor is further configured to:
determine respective first locations for the first clusters; and
determine respective second locations for the second clusters.

17. The system of claim 16, wherein to place the transportation service request in a second request queue associated with the second queuing zone, the at least one processor is further configured to:
determine a request location of the transportation service request;
determine a first cluster having a first location corresponding to the request location;
determine, among second clusters enclosed by the first cluster, a second cluster having a second location corresponding to the request location; and
determine the second request queue corresponding to the determined second cluster.

18. The system of claim 15, wherein a first number of the first clusters is associated with an area of the district and a predetermined value.

19. The system of claim 17, wherein the determined first cluster is closest to the request location among the first clusters, and the determined second cluster is closest to the request location among the second clusters.

20. A non-transitory computer-readable medium that stores a set of instructions, when executed by at least one processor of an electronic device, cause the electronic device to perform a method for providing transportation service, the method comprising:
receiving, from a remote passenger terminal, a transportation service request in a district;
detecting that the transportation service request is within a first queuing zone, the first queuing zone associated with at least one first queuing condition; and
placing the transportation service request in a first request queue associated with the first queuing zone based on a determination that the transportation service request meets the first queuing condition.
